(19) United States
(12) Patent Application Publication
(10) Pub. No.: US 2023/0398964 A1
(43) Pub. Date: Dec. 14, 2023

(54) MOUNTING ASSEMBLY FOR RECREATIONAL VEHICLE

(71) Applicant: Daniel Wayne Wilson, Elkhart, IN (US)

(72) Inventor: Daniel Wayne Wilson, Elkhart, IN (US)

(21) Appl. No.: 18/330,715

(22) Filed: Jun. 7, 2023

Related U.S. Application Data
(60) Provisional application No. 63/351,322, filed on Jun. 10, 2022.

(51) Int. Cl. B60S 9/22; B60S 9/02

(52) U.S. Cl. CPC B60S 9/22; B60S 9/02

(57) ABSTRACT

A recreational vehicle includes: an external corner area; and a mounting assembly, including a locking hook plate which is selectively coupled with and decoupled from the external corner area of the recreational vehicle.

### CROSS REFERENCE TO RELATED APPLICATIONS

This is a non-provisional application based upon U.S. provisional patent application Ser. No. 63/351,322, entitled “VERSATILE BRACKET FOR DETACHING JACKS AND ACCESSORIES”, filed Jun. 10, 2022, which is incorporated herein by reference.

### BACKGROUND OF THE INVENTION

### 1. Field of the Invention

The present invention relates to recreational vehicles, and, more particularly, to mounting devices for recreational vehicles.

### 2. Description of the Related Art

Recreational vehicles are well known. Recreational vehicles may be self-propelled or otherwise moved by another device with motive power, such as another vehicle, such as a car, truck, or van. Thus, “recreational vehicle” includes the following: motorhomes; travel trailers (which can also be referred to as travel trailer campers); folding/pop-up trailers; fifth wheels; and truck campers (carried in a bed area of pickup truck).

One or more of these types of recreational vehicles may carry or otherwise support a jack. For example, a truck camper often has a jack carried at or near the four corners of the truck camper by way of the external skin of the truck camper. Such jacks can be used, for example, to support the truck camper when the truck camper is not otherwise being carried or supported by the truck. A known mounting device for mounting such a jack at a respective corner area of the truck camper includes an angle bracket and a mounting plate. The angle bracket includes a first plate and a second plate attached to the first plate at a substantially 90° angle. The first plate is fastened to a side wall of the truck camper by way of fasteners. The second plate is attached to the mounting plate by way of fasteners. The mounting plate is further attached to a rear or front wall of the truck camper by fasteners. The jack includes a mounting rail, which is positioned adjacent to the mounting plate and includes holes which the fasteners that attach the second plate to the mounting plate also serve to attach the mounting rail of the jack to the mounting plate and thus also the second plate. A problem with such a way of attaching the jack is that the jack is not readily detached from the truck camper walls.

What is needed in the art is a way of attaching a jack to a corner area of a recreational vehicle, such as a truck camper, such that the jack is readily detachable from the corner area.

### SUMMARY OF THE INVENTION

The present invention provides a recreational vehicle mounting assembly including a locking hook plate configured for selectively coupling with and decoupling from an external corner area of the recreational vehicle.

The invention in one form is directed to a recreational vehicle, including: an external corner area; and a mounting assembly, including a locking hook plate which is selectively coupled with and decoupled from the external corner area of the recreational vehicle.

The invention in another form is directed to a mounting assembly for a recreational vehicle, the mounting assembly including: a locking hook plate configured for selectively coupling with and decoupling from an external corner area of the recreational vehicle.

The invention in yet another form is directed to a method of using a recreational vehicle, the method including the steps of: providing that the recreational vehicle includes an external corner area; and coupling, selectively, a locking hook plate of a mounting assembly of the recreational vehicle with the external corner area; and decoupling, selectively, the locking hook plate from the external corner area.

An advantage of the present invention is that it provides a way of readily and quickly attaching and detaching selectively a jack, or an accessory, to a recreational vehicle, such as a truck camper.

Another advantage is of the present invention is that the locking hook plate can be readily mounted upside down, which provides for a different mounting position for the respective jack or accessory, in order to accommodate different circumstances. Thus, a user can quickly detach or detach the jack so as to reorient the jack if necessary (i.e., turn the jack upside down) or to remove the jack altogether and to attach an accessory in place of the jack.

Yet another advantage of the present invention is that it provides for an anti-theft measure.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 illustrates a perspective, partially exploded view of a recreational vehicle, the recreational vehicle including a mounting assembly and a jack, in accordance with an exemplary embodiment of the present invention;

FIG. 2 illustrates a perspective view of the recreational vehicle of FIG. 1, the jack being mounted to the mounting assembly, in accordance with an exemplary embodiment of the present invention;

FIG. 3 illustrates a top view of the recreational vehicle of FIG. 1, with portions broken away and with structures partially spaced apart or exploded from one another, in accordance with an exemplary embodiment of the present invention;

FIG. 4 illustrates a side view of a capture plate of the mounting assembly, in accordance with an exemplary embodiment of the present invention;

FIG. 5 illustrates a side view of a spacer plate of the mounting assembly, in accordance with an exemplary embodiment of the present invention;

FIG. 6 illustrates a side view of a locking hook plate of the mounting assembly, in accordance with an exemplary embodiment of the present invention; and

FIG. 7 illustrates a flow diagram showing a method of using the recreational vehicle, in accordance with an exemplary embodiment of the present invention.

Corresponding reference characters indicate corresponding parts throughout the several views. The exemplifications set out herein illustrate at least one embodiment of the invention, and such exemplifications are not to be construed as limiting the scope of the invention in any manner.

### DETAILED DESCRIPTION OF THE INVENTION

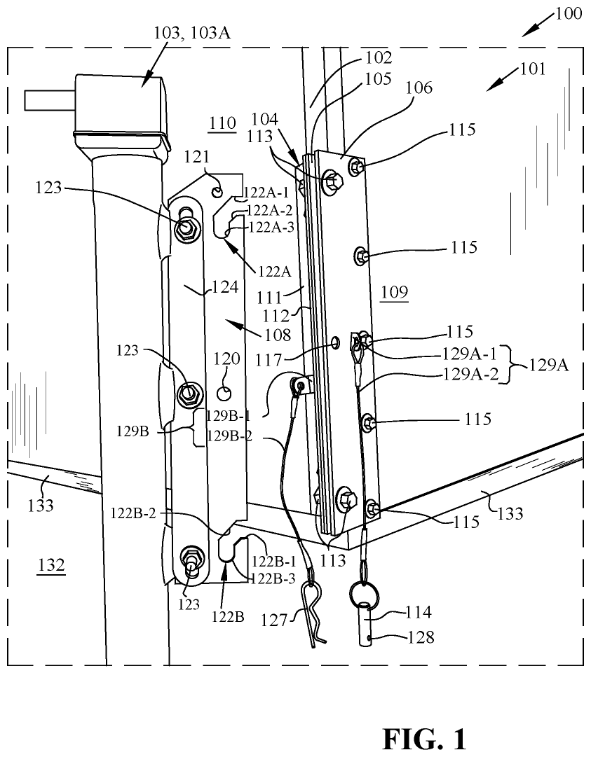

Referring now to the drawings, and more particularly to FIG. 1, there is shown, in part, a recreational vehicle 100 (RV 100). RV 100 can include any type of RV, such as motorhomes, travel trailers (which can also be referred to as travel trailer campers), folding/pop-up trailers, fifth wheels, and truck campers (carried in a bed area of a pickup truck). Herein, it is assumed that RV 100 is a truck camper (thus, truck camper 100, or camper 100). Truck campers 100 are well known in the art and thus will not be described or shown in detail below, except as the present invention is concerned.

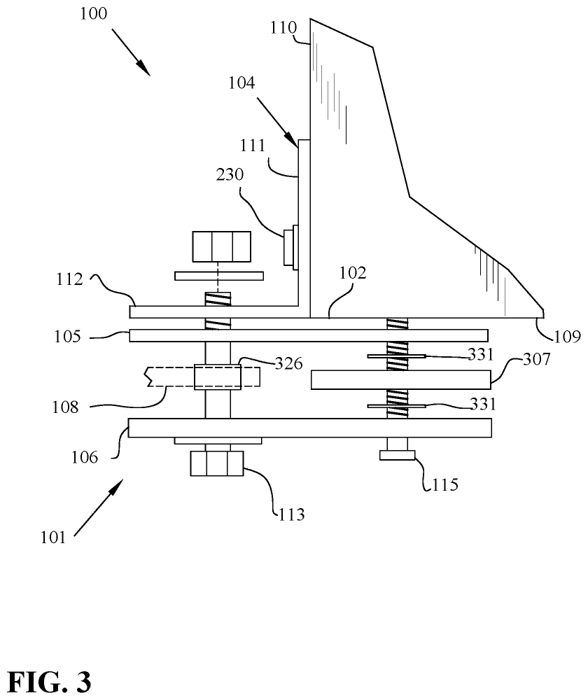

Truck camper 100 includes a plurality of walls with an external skin, these walls including a front wall, rear wall 109, left side wall 110, and a right side wall, these four walls forming four corner areas. FIG. 1 shows left side wall 110 and rear wall 109 which together form a corner area 102. Truck camper 100 further includes a mounting assembly 101. Mounting assembly 101 is connected to an external portion of truck camper 100 in corner area 102 of truck camper 100; considering that truck camper 100 has four corners, then truck camper 100 includes four mounting assemblies 101, one assembly 101 at each corner area 102. Unless otherwise stated, each mounting assembly 101 is substantially identical to one another (making necessary adjustments in configuration considering that each mounting assembly 101 is at a different corner area 102); thus, a description of one mounting assembly serves substantially as a description of the other mounting assemblies 101. Mounting assembly 101 generally includes an angle bracket 104, a mounting plate 105, a capture plate 106, a spacer plate 307 (FIGS. 3 and 5), and a locking hook plate 108. Truck camper 100 further includes a jack 103 releasably mounted to mounting assembly (thus, four jacks 103, one for each mounting assembly 101, at each of the four corner areas 102). Jack 103 is a well known device and thus will not be described or shown in detail. As is known, jack 103 is used to support remaining portions of truck camper 100 (for example, on the ground) when truck camper 100 is not otherwise being carried or supported by the pickup truck. In accordance with the present invention, jack 103 can support truck camper 100 by way of mounting assembly 101. FIG. 1 shows jack 103 detached from remaining portions of RV 100, for illustrative purposes (further for illustrative purposes, in the perspective view of FIG. 1, jack 103 is set at an angle different from an angle that jack 103 would be at if jack 103 were mounted to capture plate 106, for instance). Further, in FIG. 1 (though not clearly visible in FIG. 1), jacks 103 are supporting remaining portions of camper 100 off of a floor 132.

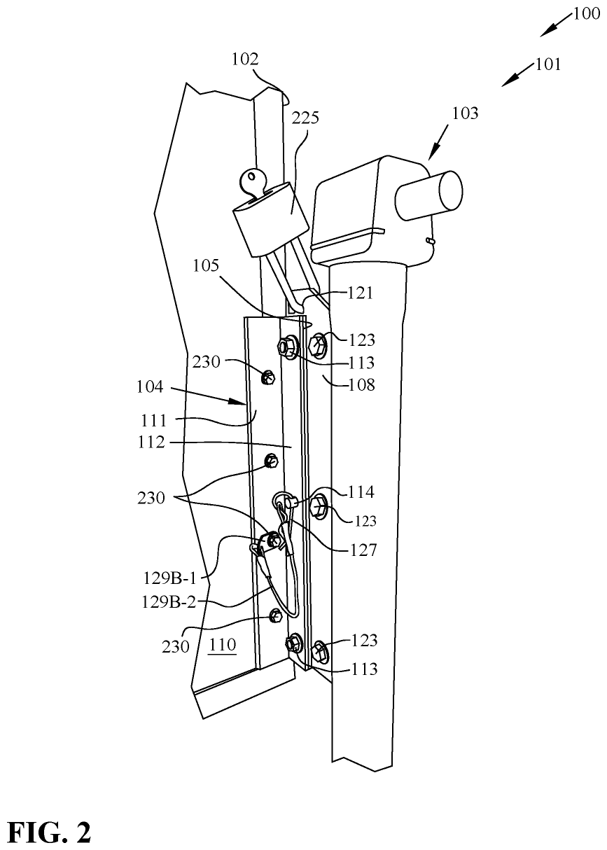

Angle bracket 104 includes a first plate 111 and a second plate 112 attached to first plate 111. Angle bracket 104 can be made of any suitable material (such as stainless steel) and can be made in any suitable manner. Though not shown, first plate 111 is attached to left side wall 110 in any suitable manner, which can be a known manner, such as by way of fasteners 230 (FIG. 2), which can proceed through holes of first plate 111 and into left side wall 110 for securement to left side wall 110. Thus, angle bracket 104 can be positioned externally adjacent to left side wall 110 at corner area 102. Further, second plate 112 (which forms substantially a 90° angle with first plate 111) includes three holes near an outer edge of second plate 112. Two of these holes can be near top and bottom corners of second plate 112 (thus, these two holes can be referred to as top and bottom corner holes of second plate 112) and receive fasteners 113, such as bolts, screws, or the like, which can be secured by way of nuts, or the like (for example, bolt 113 is optionally paired with a self-locking nut). Fasteners 113 secure second plate 112 to mounting plate 105, and further to capture plate 106 (with mounting plate 105 being positioned between second plate 112 and capture plate 106). The third of these holes (the third hole can be referred to as the central hole of second plate 112) is positioned between the top and bottom corner holes of second plate 112. The central hole of second plate 112 releasably receives pin 114 (which can also be referred to as a clevis pin, and can be a ⅜ inch pin) of mounting assembly 101 in order to secure locking hook plate 108 (and thus jack 103, for example). Pin 114 is thus configured for removably coupling locking hook plate 108 with capture plate 106 and mounting plate 105. Further, according to one embodiment of the present invention, angle bracket 104 has a length that substantially matches a length of mounting plate 105, a length of capture plate 106, and a length of spacer plate 307 (the length of each of which can be approximately thirteen inches. It can be appreciated that the present invention is not limited to any dimensions mentioned herein. Further, according to the embodiment shown in FIG. 1, each of angle bracket 104, mounting plate 105, and capture plate 106 end at about the top of trim 133 of walls 109, 110.

Mounting plate 105 can be made of any suitable material (such as stainless steel) and can be made in any suitable manner. Mounting plate 105 includes a first longitudinal edge and a second longitudinal edge opposing the first longitudinal edge, wherein the first longitudinal edge includes five through holes spaced apart longitudinally from one another (these five holes can be referred to herein as the holes of the first longitudinal edge), and the second longitudinal edge includes three holes spaced apart longitudinally from one another (these three holes can be referred to herein as the holes of the second longitudinal edge)(mounting plate 105 is substantially similar to capture plate 106, and thus a structural description and illustration of capture plate 106, below, serves as a structural description and illustration of mounting plate 105 (though mounting plate 105 and capture plate 106 can optionally have different thicknesses relative to one another, as shown in FIG. 3), but mounting plate 105 and capture plate 106 serve different functions. Mounting plate 105 is attached to the rear or front wall of truck camper 100; FIG. 1 shows that mounting plate 105 is attached to rear wall 109. More specifically, the five holes of the first longitudinal edge of mounting plate 105 receive fasteners 115, such as bolts, screws, or the like, which can be secured by way of nuts, or the like, and thereby fasteners 115 secure mounting plate 105 to rear wall 109. Further, the top and bottom holes of the second longitudinal edge of mounting plate 105 receive fasteners 113, so as to secure mounting plate 105 to second plate 112 of angle bracket 104.

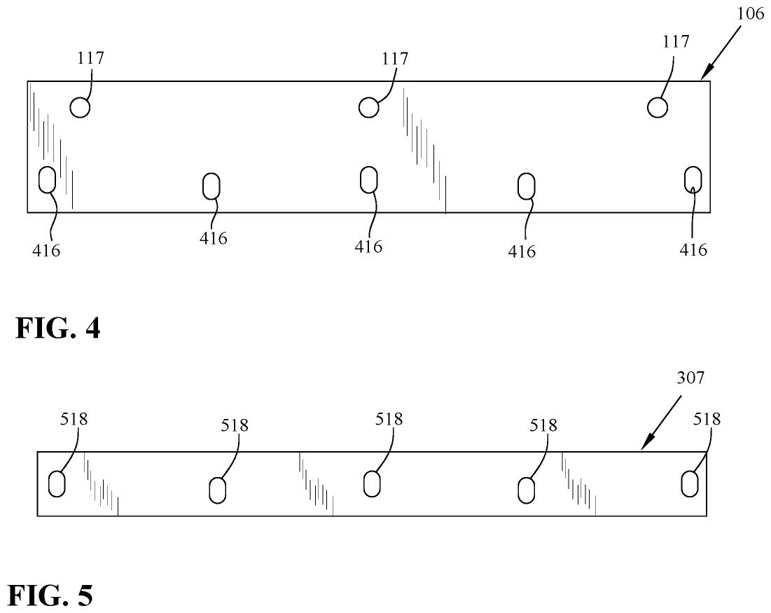

Capture plate 106 can be made of any suitable material (such as stainless steel) and can be made in any suitable manner. Capture plate 106 includes a first longitudinal edge and a second longitudinal edge opposing the first longitudinal edge, wherein the first longitudinal edge includes five through holes 416 (FIG. 4) spaced apart longitudinally from one another, and the second longitudinal edge includes three holes 117 spaced apart longitudinally from one another. The five holes 416 of the first longitudinal edge of capture plate 106 receive fasteners 115, which thereby secure capture plate 106 to mounting plate 105 and thus also to rear wall 109. Further, top and bottom holes 117 of the second longitudinal edge of capture plate 105 receive fasteners 113, so as to secure capture plate 106 to mounting plate 105 and thus also to second plate 112 of angle bracket 104. Central hole 117 of the second longitudinal edge of capture plate 105 releasably receives pin 114 in order to secure locking hook plate 108 (and thus jack 103, for example). Capture plate 106 substantially mirrors mounting plate 105.

Spacer plate 307 (FIGS. 3 and 5)(not visible in FIG. 1) can be made of any suitable material (such as stainless steel) and can be made in any suitable manner. Spacer plate 307 is positioned between mounting plate 105 and capture plate 106. Spacer plate 307 is about half the width of mounting plate 104 and capture plate 106. Spacer plate 307 includes five holes 518 (FIG. 5) spaced apart along the longitudinal extend of spacer plate 307. These five holes 518 of spacer plate 307 align with the five holes of the first longitudinal edge of mounting plate 105 and with the five holes 115 of the first longitudinal edge of capture plate 106. Thus, five holes 518 of spacer plate 307 also receive fasteners therethrough. Spacer plate 307 serves to fill space between mounting plate 105 and capture plate 106.

Mounting assembly 101 further includes a plurality of spacers 326 (FIG. 3). According to the present embodiment of the present invention, two spacers 326 are provided. Each spacer 326 (which can be referred to as a bushing) can be made of any suitable material, such as stainless steel, and can have an annular configuration, with an inner diameter (i.e., 0.375 inches), an outer diameter (i.e., 0.5 inches), and a width (i.e., 0.22 inches). Each spacer 326 mounts to a corresponding fastener 113, such that the inner diameter of each spacer 326 circumferentially surrounds the outer perimeter of fastener 113, such as a portion of a bolt 113. In this way, spacers 326 are substantially sandwiched between, or at least positioned between, mounting plate 105 and capture plate 106.

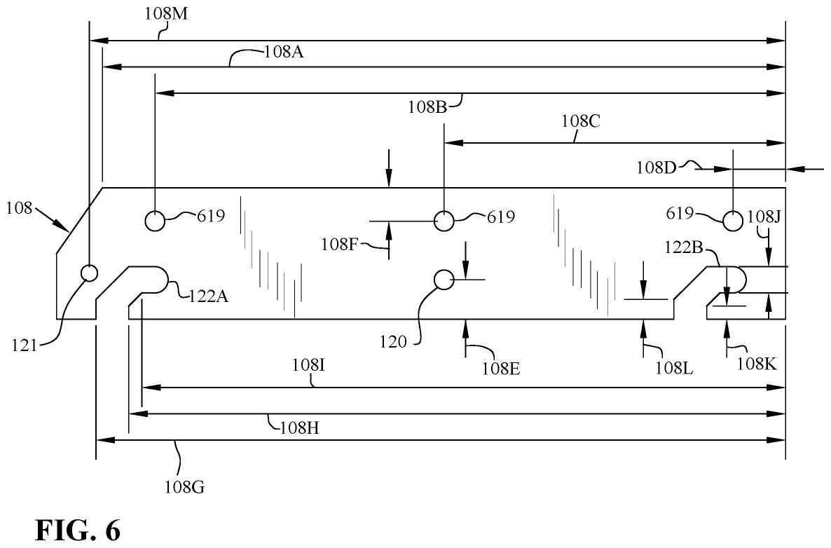

Locking hook plate 108 detachably couples jack 103 with mounting plate 105 and capture plate 106 by way of fasteners 113 and pin 114. Locking hook plate 108 is shown in FIG. 1 but is more fully shown in FIG. 6. Locking hook plate 108 includes three holes 619 (FIG. 6), a central hole 120, a longitudinal end hole 121, and two angled slots 122A, 122B (which are substantially similar to one another). Holes 619 align with holes formed in a mounting rail 124 of jack 103, such that holes 619 and these holes of the mounting rail 124 together receive fasteners 123, such as bolts, screws, or the like, which can be secured by way of nuts, or the like. In this way, fasteners 123 secure mounting rail 124 (and thus jack 103) to locking hook plate 108. When locking hook plate 108 is coupled with capture plate 106, central hole 120 aligns with the central hole of second plate 112 of angle bracket 104, the central hole of the second longitudinal edge of mounting plate 105, and the central hole 117 of capture plate 106. When this alignment occurs, pin 114 is received in each of central hole 120, the central hole of second plate 112 of angle bracket 104, the central hole of the second longitudinal edge of mounting plate 105, and the central hole 117 of capture plate 106, which helps to secure locking hook plate 108 to angle bracket 104, mounting plate 105, and capture plate 106. Longitudinal end hole 121 is configured to receive a padlock 225 (FIG. 2) in order to secure locking hook plate 108 to angle bracket 104, mounting plate 105, and capture plate 106, and thereby to provide an anti-theft measure to help prevent theft of, for example, jack 103 from track camper 100. Each of angled slots 122A, 122B includes an entry section 122A-1, 122B-1, and intermediate section 122A-2, 122B-2, and a distal section 122A-3, 122B-3. When locking hook plate 108 couples with mounting plate 105 and capture plate 106, angled slots 122A, 122B mount to a corresponding spacer 326. That is, entry sections 122A-1, 122B-1 initially receive corresponding spacers 326, which subsequently slide down intermediate sections 122A-2, 122B-2 and come to rest in distal sections 122A-3, 122B-3. Pin 114 is then inserted in each of central hole 120, the central hole of second plate 112 of angle bracket 104, the central hole of the second longitudinal edge of mounting plate 105, and the central hole 117 of capture plate 106, and pin 114 can be further secured to plates 104, 105, 106, 108 by way of a hairpin clip 127 of mounting assembly 101 inserted through a hole 128 formed in a distal end of pin 114. Thus, locking hook plate 108 is configured for selectively coupling with and decoupling from an external corner area 102 of RV 100

Jack 103—more specifically, a portion thereof (considering that jack 103 is well known)—is also shown in FIG. 1. Jack 103 includes a tubular structure and mounting rail 124 attached (such as by welding) to the tubular structure. A side of mounting rail 124 is attached to a side of locking hook plate 108. Further, though not shown, jack 103 can be detached from locking hook plate 108 and attached to an accessory (more below)(or alternatively, a separate locking hook plate 108 can be attached to the accessory), and the accessory can be coupled with mounting plate 105 and capture plate 106 by way of locking hook plate 108.

In an upright orientation, locking hook plate 108 mounts to spacers 326 as indicated in FIG. 1. That is, angled slot 122A mounts to the top spacer 326 and thus couples with the top fastener 113 in FIG. 1, and angled slot 122B mounts to the bottom spacer 326 and thus couples with the bottom fastener 113 in FIG. 1. Alternatively, a user can selectively employ an upside-down orientation. That is, angled slot 122A mounts to the bottom spacer 326 and thus couples with the bottom fastener 113 in FIG. 1, and angled slot 122B mounts to the top spacer 326 and thus couples with the top fastener 113 in FIG. 1. A user may wish to use the upside-down orientation when, for example, there may be a need to protect jack 103, such as in off-road, bumpy driving conditions, that might cause a jack 103 to come into contact with the ground and thereby damage jack 103, mounting assembly 101, or other portions of RV 100.

Mounting assembly 101 includes not only pin 114 and hairpin clip 127 but also retention assemblies 129A, 129B for pins 114, 127, respectively. Retention assemblies 129A, 129B serve to keep pins 114, 127 together with other portions of mounting assembly 101, and retention assemblies 129A, 129B can be made of any suitable material and in any suitable manner. Each retention assembly 129A, 129B includes a retention base 129A-1, 129B-1 and a retention tether 129A-2, 129B-2. Retention bases 129A-1, 129B-1 can each be a plate that is attached to or secured by a respective fastener 115, 230 at a proximal end of retention bases 129A-1, 129B-1 and to retention tethers 129A-2, 129B-2 at an opposing distal end of retention bases 129A-1, 129B-1. Optionally, retention bases 129A-1, 129B-1 can be bent so that a distal portion of the respective retention bases 129A-1, 129B-1 projects away from an associated structure, such as capture plate 106 with respect to retention base 129A-1 and angle bracket 104 (more specifically, first plate 111) with respect to retention base 129B-1, as indicated in FIG. 1 (see also FIG. 2). The proximal end of retention bases 129A-1, 129B-1 can include a hole that surrounds a respective fastener 115, 230 and can be further clamped down to a side of capture plate 106 (with respect to retention base 129A-1) and to a side of angle bracket 104 (more specifically, first plate 111)(with respect to retention base 129B-1) by way of a head of a respective fastener 115, 230 and/or a washer, as indicated in FIG. 1 (see also FIG. 2). The distal end of retention bases 129A-1, 129B-1 can further include a hole, which receives a loop of retention tether 129A-2, 129B-2, respectively. Retention bases 129A-1, 129B-1 can be made of any suitable material, such as aluminum, and in any suitable manner. Retention tethers 129A-2, 129B-2 can be, for example, wire lanyard and serve to couple retention bases 129A-1, 129B-1 with pins 114, 127, respectively. Retention tethers 129A-2, 129B-2 can be made of any suitable material, such as a metal or a polymer (loops of retention tethers 129A-2, 129B-2 can be formed in any suitable manner, such as using a metallic band or electrical tape). Optionally, as shown in FIG. 1, retention assembly 129A can further include a ring, which couples a distal end of retention tether 129A-2 with pin 114. According to an alternative embodiment of retention assembly 129A (and similarly with respect to retention assembly 129B), retention base 129A-1 can be substantially shorter than what is shown in FIG. 1 and have no bend as shown in FIG. 1; further, a proximal end of retention tether 129A-2 can be crimped to retention base 129A-1, and a distal end of retention tether 129A-2 can have a loop that is secured directly to a hole in a proximal end of pin 114. Prior to installation of any pertinent parts of mounting assembly 101, pins 114, 127 can be pre-attached to lanyards 129A-2, 129B-2.

Referring now to FIG. 2, there is shown a perspective view of RV 101, with jack 103 being mounted to mounting assembly 101. More specifically, angled slots 122A, 122B are mounted to spacers 326 and thus between mounting plate 105 and capture plate 106. Further, pin 114 is shown to be mounted in the associated holes (central hole 120, the central hole of second plate 112 of angle bracket 104, the central hole of the second longitudinal edge of mounting plate 105, and the central hole 117 of capture plate 106), with hairpin clip 127 (which can also be referred to as a pin) being attached to pin 114. Further, padlock 225 is secured to hole 121 of locking hook plate 108, by preventing capture plate 108 from moving downwards. Thus, jack 103 is readily attached (and detached) to other portions of RV 100 by way of mounting assembly 101.

Further, FIG. 2 shows that first plate 111 of angle bracket 104 is secured to left side wall 110 using a plurality (in this embodiment, four) fasteners 230 (such as bolts, screws, or the like, which can be secured by way of nuts, or the like) in associated holes (not visible) in first plate 111. According to an embodiment, fasteners 230, 115 can be the same sized lag bolt and thus be substantially identical to one another.

Referring now to FIG. 3, there is shown a top view of RV 100, including mounting assembly 101, with portions broken away, and with structures partially spaced apart or exploded from one another, for illustrative purposes. Trim 133 (which is horizontal trim) and vertical trim (unlabeled but shown in FIGS. 1-2 in corner area 102) are omitted from FIG. 3 for illustrative purposes. This figure shows only the top-most fasteners 113, 115, and omits, for example, padlock 225 and retention assemblies 129A, 129B, for illustrative purposes. Mounting assembly 101 is shown to include angle bracket 104 (attached to left side wall 110 by fasteners 230), mounting plate 105 (attached to rear wall 109 by fasteners 115 and to angle bracket 104 by fasteners 113), capture plate 106 (coupled to rear wall 109 by fasteners 115 and mounting plate 105 and to angle bracket 104 by fasteners 113). According to one embodiment, fasteners 113 can be 0.375 inch bolts (such as stainless steel hex bolts, with 1.5 inch length), the washers (unlabeled) with fasteners 113 can be, for example, 0.375 inch stainless steel washers, and the nut (unlabeled) secured to the end of fastener 113 can be a 0.375 inch self-locking nut (such as stainless steel and/or nylon locking nuts). Further, fasteners 115, according to one embodiment, can be lag bolts. Further, shims 331 of mounting assembly 101 are positioned between mounting plate 105 and spacer plate 307 and between spacer plate 307 and capture plate 106 (two shims 331 per fastener 115, resulting in ten shims 331 in total). Shims 331 each have an annular configuration (such as a 1016 shim, and/or 0.020 black carbon spacer washers). Further, mounting assembly 101 is also shown to include spacers 326, which are mounted by their inner diameters circumferentially to bolts or screws 113, spacers 326 being positioned between mounting plate 105 and capture plate 106, opposite spacer plate 307. Locking hook plate 108 is shown in broken lines (for illustrative purposes) to be mounted to a top spacer 326. Further, according to an embodiment of the present invention, angle bracket 104 and mounting plate 105 have substantially the same thickness relative to one another; capture plate 106, spacer plate 307, and locking hook plate 108 have substantially the same thickness relative to one another; and the thickness of capture plate 106, spacer plate 307, and locking hook plate 108 is larger than the thickness of angle bracket 104 and mounting plate 105; nevertheless, it can be appreciated that the present invention is not limited to relative thicknesses of structures 104, 105, 106, 307, 108.

Referring now to FIG. 4, there is shown a side view of capture plate 106. Capture plate 106 is shown to include holes 117 and holes 416. According to one embodiment, capture plate 106 includes a length of 13 inches, a width of 2.5 inches, and a thickness (into the sheet of paper of FIG. 4) of 0.179 inches, holes 117 can have a diameter of 0.375 inches, and holes 416 can have a longitudinal extent of 0.5 inches and a width of 0.312 inches.

Referring now to FIG. 5, there is shown a side view of spacer plate 307. Spacer plate 307 is shown to include holes 518. According to one embodiment, spacer plate 307 includes a length of 13 inches, a width of 1.25 inches, and a thickness (into the sheet of paper of FIG. 5) of inches, and holes 518 can have a longitudinal extent of 0.5 inches and a width of 0.312 inches.

Referring now to FIG. 6, there is shown a side view of locking hook plate 108. According to one embodiment of locking hook plate 108, locking hook plate 108 includes a length of 13.875 inches, a width of 2.5 inches, and a thickness of 0.179 inches, holes 619 and 120 can each have a diameter of 0.375 inches, and hole 121 can have a diameter of 0.312 or inches. Further, locking hook plate 108 can include a distance 108A of 13 inches, a distance 108B of 12 inches, a distance 108C of 6.5 inches, a distance 108D of 1.0 inch, a distance 108G of 13.625 inches, a distance 108H of 12.5 inches, a distance 108I of 12.25 inches, a distance 108J of 0.5 inches, a distance 108K of 0.25 inches, a distance 108L of 0.375 inches, and a distance 108M of 13.375 inches.

Above, it was noted that mounting assembly 101 can optionally be used on any other corners 102 of RV 101. Rather than being mounted to the left-rear corner 102, mounting assembly 101 could also be mounted to the left-front corner as well, for example. To accomplish this, a difference (as compared to FIG. 1) is that angle bracket 104 could be turned upside down, so that first plate 111 could be mounted to left side wall 110.

The following is provided in summary. Capture plate 106 is configured for being coupled with external corner area 102. Capture plate 106 is configured for being coupled with mounting plate 105—in mirroring relationship with mounting plate 105—and angle bracket 104 in order for capture plate 106 to couple with corner area 102 of RV 100. Locking hook plate 108 is selectively detachably coupled with capture plate 106. Further, locking hook plate 108 is configured for being coupled with jack 103 or an accessory 103A. Herein, though the figures depict 103 (and 103A) as a jack, reference character 103A is being used to represent a generic accessory in place of the jack, wherein the accessory 103A can attach to locking hook plate 108 in place of the jack 103. Spacer plate 307 is configured for being positioned between capture plate 108 and mounting plate 105. Mounting assembly 101 further includes fasteners 113 and spacers 326 each of which is attached to a respective one of fasteners 113, fasteners 113 being configured for attaching capture plate 106 to mounting plate 105 and angle bracket 104, wherein locking hook plate 108 includes an angled slots 122A, 122B, each of which is configured for receiving a respective one of spacers 326 therein.

The present invention thus advantageously provides a versatile locking hook plate 108 for attaching/detaching jacks 103 or accessories 103A to other portions of mounting assembly 101. The present invention also provides mounting assembly 101 for use with jack 103 or recreational and utilitarian accessories 103A. Mounting assembly 101 thus provides a way to quickly detach and secure truck camper jacks 103, while also providing a stable platform for the mounting of accessories 103A. Such accessories 103A can include, but not be limited to, stoves, tables, shelves, benches, removable ladders, flags, entertainment devices such as televisions, sound speakers, clotheslines, trays, pot hangers, food preparation devices, and other camping accessories. Further, a utilitarian market associated with recreational vehicles and camping can benefit from using mounting assembly 101 in connection with a removable ladder and bench mounting device (i.e., an L-shaped bracket or bracket assembly, which the inventor has devised, used to mount, for instance, a shelf or small table to locking hook plate 108 and thus to remaining portions of mounting assembly 101), while mounting assembly 101 also has the ability couple interchangeably with—and thereby carrying—a different variety and shape of loads. The present invention also advantageously provides structure (i.e., capture plate 106, locking hook plate 108, spacer plate 307, spacers 326) that can simply be added to existing or new four-corner jack systems for slide-in truck campers, wherein the present invention provides for the ability to remove jack 103 without the use of tools, and provides for a measure of anti-theft for the mounting of jacks 103 and accessories 103A. Further, locking hook plate 108 may be inverted (turned upside down) with jack 103 in order to store jack 103 for safety and/or when uneven off-road conditions prevail that may damage the vehicle (such as the truck carrying truck camper 101) or jacks 103. Further, mounting choices for mounting of locking hook plate 108 and/or other portions of mounting assembly 101 for recreational and utility vehicle applications are only limited by the strength and the material being used in the manufacturing and the subject vehicle's restrictions and guidelines. Further, the present invention can be provided so as to be compatible with most power and manual jack mounting bolt patterns of major manufacturers.

In use, mounting assembly 101, or at least parts thereof, must first be installed to other portions of truck camper 100. For instance, truck camper 100 may already have jack 103 coupled with angle bracket 104 and mounting plate 104, according to prior art; this is assumed to be the case in this paragraph. Thus, to begin with, first plate 111 of angle bracket 104 (less retention assembly 129B) is already attached to corner area 102 using fasteners 230 (×4), mounting plate 105 (less retention assembly 129A) is already attached to corner area 102 using fasteners 115 (×5), mounting plate 105 is already attached to second plate 112 of angle bracket 104 using fasteners 113 (×3)(or, alternatively, different fasteners (other than 113), such as a bolt, and associated washers and/or nuts, supplied for example by the OEM of truck camper 100) in corresponding holes of second plate 112 (namely, the three holes of second plate 112) and mounting plate 105 (namely, the three holes of the second longitudinal edge of mounting plate 105), and mounting rail 124 of jack 103 (and thus also jack 103) is already attached to mounting plate 105 using fasteners 123 (×3) in three holes of mounting rail 124 and the three holes of the second longitudinal edge of mounting plate 105. However, to make use of the present invention, a portion of what is already installed must be undone, and additional parts must be installed, using a few hand tools. Before beginning the installation of mounting assembly 101 in accordance with the present invention, the user is advised to ensure that truck camper 100 is on a stable and secure surface where removal of lifting jacks 103 will be possible. Further, user should perform a maintenance and service inspection of the four corner areas 102 of truck camper 100, looking for signs of damage or water infiltration. Then, remove the lowest one of fasteners 115 (i.e., a lag/mounting bolt), inspecting this fastener 115 for rust, mold, moisture, or breakage; if damage or leakage is noticed in any corner thereof, user should halt installation and consult a qualified technician or otherwise provide proper notice before continuing installation. The following description pertains to all four corner areas 102, though installation with reference to only one corner area 102 is described. Next, unbolt jack 103 from corner area 103, making sure to retain any factory bolts for later use. If truck camper 100 has electric power heads installed on jacks 103 but not quick-connect plugs, it is advisable to consider installing at this time. Next, remove remaining four bolts 115 and save. Next, installer may add a sealant into any exposed holes of truck camper 100 to ensure a water tight sealant installation. Next, attach shims 331, spacer plate 307, fasteners 115, fasteners 113 (and associated fasteners such as washers and/or self-locking nuts, wherein such fasteners 113, washers, and/or self-locking nuts, if not supplied by the OEM of truck camper 101, can be supplied to installer as parts of a kit, such as an after-market kit, which does not necessarily include angle bracket 104, mounting plate 105, or fasteners 230, but can further include capture plate 106, spacer plate 307, locking hook plate 108, fasteners 115, spacers 326, and shims 331), spacers 326, capture plate 106 to angle bracket 104 and mounting plate 105, but do not tighten yet and thus leave loosely connected to angle bracket 104 and mounting plate 105. Next, slip locking hook plate 108 into position—using angled slots 122A, 122B—over spacers 326, and insert pin 114 in its properly aligned holes as described above (i.e., hole 120) in order to ensure proper alignment. Begin to tighten the various fasteners (i.e., 115, 113) equally until the side-to-side motion is almost completely eliminated or until desired effect is achieved without pinching hook plate 108. Pay special attention to spacer plate 307 so that it is resting on or touching locking hook plate 108 when locking hook plate 108 is in locked position. Next, unpin locking hook plate 108, and bolt locking hook plate 108 to mounting rail 124 of jack 103 with existing bolts saved from earlier. Installation should now be complete. If jacks 103 are equipped with a power head, it is advisable to add a quick-connect plug at this time. Alternatively (in terms of order), installer can initially remove jack 103 from truck camper 100, and then can fasten locking hook plate to mounting rail 124 of jack 103. Installer can then set jack 103 and locking hook plate 108 to the side. Using fasteners 115, 113 (i.e., screws and/or bolts), installer then installs spacer plate 307 thereon, followed by capture plate 106 with shims 331, spacers 326, and any washers, and installer can then retighten fasteners 115, 113. Locking hook plate 108 (with jack 103 attached thereto) is then slid into place using angled slots 122A, 122B and central hole 120 with pins 114, 127.

Further, during use, padlock 225 can be locked by way of hole 121. To remove jack 103, user removes padlock 225, removes pins 114, 127, and takes locking hook plate 108 off of spacers 326. If user wishes to employ an accessory 103A instead of jack 103, optionally locking hook plate 108 can be removed from jack 103 and attached to accessory 103A, and then locking hook plate 108 can be slipped back onto spacers 326 using angled slots 122A, 122B.

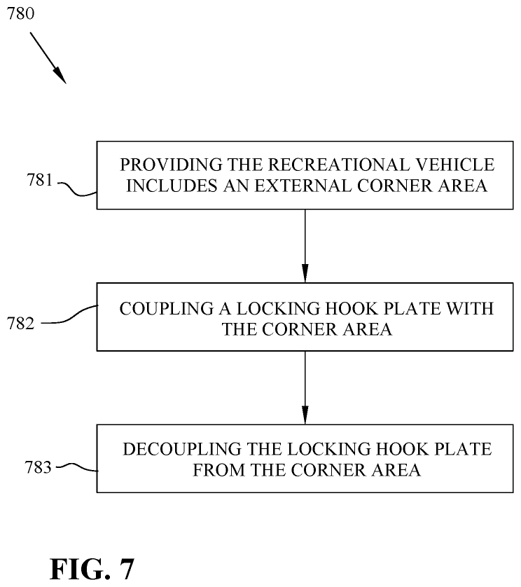

Referring now to FIG. 7, there is shown a flow diagram showing a method 780 of using RV 100. Method 780 includes the steps of: providing 781 that the recreational vehicle 100 includes an external corner area 102; and coupling 782, selectively, locking hook plate 108 of mounting assembly 101 of RV 100 with external corner area 102; and decoupling 783, selectively, locking hook plate 108 from external corner area 102. Mounting assembly 101 can further include capture plate 106 which is coupled with external corner area 102 of RV 100, locking hook plate 108 being selectively detachably coupled with capture plate 106. RV can further include a jack mechanism 103 or an accessory 103A, locking hook plate 108 being coupled with jack mechanism 103 or accessory 103A. Mounting assembly 101 can further include mounting plate 105 and angle bracket 104, capture plate 106 being coupled with mounting plate 105—in mirroring relationship with mounting plate 105—and angle bracket 104 such that capture plate 106 couples with external corner area 102 of RV 100. Mounting assembly 101 can further include spacer plate 307 positioned between capture plate 106 and mounting plate 106. Mounting assembly 101 can further include a plurality of fasteners 113 and a plurality of spacers 326 each of which is attached to a respective one of the plurality of fasteners 113, the plurality of fasteners 113 attaching capture plate 106 to mounting plate 105 and angle bracket 104, wherein locking hook plate 108 includes a plurality of angled slots 122A, 122B, each of angled slots 122A, 122B receiving a respective one of the plurality of spacers 326 therein.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A recreational vehicle, comprising:
an external corner area; and
a mounting assembly, including a locking hook plate which is selectively coupled with and decoupled from the external corner area of the recreational vehicle.

2. The recreational vehicle of claim 1, wherein the mounting assembly further includes a capture plate which is coupled with the external corner area of the recreational vehicle, the locking hook plate being selectively detachably coupled with the capture plate.

3. The recreational vehicle of claim 2, further comprising a jack mechanism or an accessory, the locking hook plate being coupled with the jack mechanism or the accessory.

4. The recreational vehicle of claim 3, wherein the mounting assembly further includes a mounting plate and an angle bracket, the capture plate being coupled with the mounting plate—in mirroring relationship with the mounting plate—and the angle bracket such that the capture plate couples with the external corner area of the recreational vehicle.

5. The recreational vehicle of claim 4, wherein the mounting assembly further includes a spacer plate positioned between the capture plate and the mounting plate.

6. The recreational vehicle of claim 4, wherein the mounting assembly further includes a plurality of fasteners and a plurality of spacers each of which is attached to a respective one of the plurality of fasteners, the plurality of fasteners attaching the capture plate to the mounting plate and the angle bracket, wherein the locking hook plate includes a plurality of angled slots, each of the angled slots receiving a respective one of the plurality of spacers therein.

7. A mounting assembly for a recreational vehicle, the mounting assembly comprising:
a locking hook plate configured for selectively coupling with and decoupling from an external corner area of the recreational vehicle.

8. The mounting assembly of claim 7, further comprising a capture plate configured for being coupled with the external corner area of the recreational vehicle, the locking hook plate being selectively detachably coupled with the capture plate.

9. The mounting assembly of claim 8, wherein the locking hook plate is configured for being coupled with a jack mechanism or an accessory.

10. The mounting assembly of claim 9, wherein the capture plate is configured for being coupled with a mounting plate—in mirroring relationship with the mounting plate—and an angle bracket in order for the capture plate to couple with the external corner area of the recreational vehicle.

11. The mounting assembly of claim 10, further comprising a spacer plate configured for being positioned between the capture plate and the mounting plate.

12. The mounting assembly of claim 10, further comprising a plurality of fasteners and a plurality of spacers each of which is attached to a respective one of the plurality of fasteners, the plurality of fasteners being configured for attaching the capture plate to the mounting plate and the angle bracket, wherein the locking hook plate includes a plurality of angled slots, each of the angled slots being configured for receiving a respective one of the plurality of spacers therein.

13. A method of using a recreational vehicle, the method comprising the steps of:
providing that the recreational vehicle includes an external corner area; and
coupling, selectively, a locking hook plate of a mounting assembly of the recreational vehicle with the external corner area; and
decoupling, selectively, the locking hook plate from the external corner area.

14. The method of claim 13, wherein the mounting assembly further includes a capture plate which is coupled with the external corner area of the recreational vehicle, the locking hook plate being selectively detachably coupled with the capture plate.

15. The method of claim 14, wherein the recreational vehicle includes a jack mechanism or an accessory, the locking hook plate being coupled with the jack mechanism or the accessory.

16. The method of claim 15, wherein the mounting assembly further includes a mounting plate and an angle bracket, the capture plate being coupled with the mounting plate—in mirroring relationship with the mounting plate—and the angle bracket such that the capture plate couples with the external corner area of the recreational vehicle.

17. The method of claim 16, wherein the mounting assembly further includes a spacer plate positioned between the capture plate and the mounting plate.

18. The method of claim 16, wherein the mounting assembly further includes a plurality of fasteners and a plurality of spacers each of which is attached to a respective one of the plurality of fasteners, the plurality of fasteners attaching the capture plate to the mounting plate and the angle bracket, wherein the locking hook plate includes a plurality of angled slots, each of the angled slots receiving a respective one of the plurality of spacers therein.
